(19) United States
(12) Patent Application Publication
(10) Pub. No.: US 2008/0195974 A1
(43) Pub. Date: Aug. 14, 2008

(54) Computer Oriented Way Device By Three-Dimensional Image

(76) Inventor: Rodolfo Vasone, San Paulo-SP (BR)

Correspondence Address: K.F. ROSS P.C., 5683 RIVERDALE AVENUE, SUITE 203 BOX 900, BRONX, NY, 10471-0900, US

(21) Appl. No.: 10/568,199

(22) PCT Filed: Feb. 11, 2005
(86) PCT No.: PCT/BR2005/000018

§ 371 Date: Feb. 10, 2006

(51) Int. Cl. G06F 3/048

(52) U.S. Cl. 715/825

(57) ABSTRACT

The invention is a computer-oriented device aimed for real-time location of a desired three-dimensional physical location by way of computer icons on screen or by voice activation.

### PURPOSE

The present Descriptive Report refers to an innovative program which purpose is the real simulation of the shortest and better way to be crossed by the user, from the point where the equipment for consulting is located up to the place chosen for the user himself, by means of a three-dimensional image that accurately reproduces the whole structure of the environment in which the user is traveling.

### FIELD OF THE INVENTION

This patent belongs to the field of computer science, being applicable in different areas, such as shopping centers, museums, big stores, supermarkets, companies, houses of entertainment, theaters, fairs, events, among others, being endowed with innovative concepts, that allow to improve the search and the location of the users inside the big commercial, industrial or similar points, compared to other usually found in the market, these based on pamphlets, maps, signs or sound indications.

There is, therefore, in the current request of patent, a projected and developed device with the highest technology, to get enormous feasibility and efficiency, making possible to be applied in real time, showing the user where the products for him searched are located, the pieces and works of art (in the museum case), the chairs or tables (in the case of houses of entertainment), departments (in the case of companies), among other innumerable examples, awakening the fidelity of the consumer.

### BACKGROUND OF THE INVENTION

The constructed environments destined to the commercial activities are projected differently from the common room, due to rising requirement of places that help with a high dynamic and allow a greater amount and movement of people. Besides this, the commerce, the cultural nd mercantile activities are divided into some areas of activities, being joined according to the requirements and necessities for the attendance the consuming public.

In the current building processes of the great shopping centers, for example, the main activities are related to personal interests, such as clothes, feeding, tourism, furniture, fun and entertainment, in a compatible logistic to the common areas.

In the case of cultural events in museums and fairs of expositions, the items presented are commanded by chronological or authorial form.

Therefore, the system of physical distribution of the stores, items, etc, is changeable and peculiar for each situation, becoming it into an unexpected search on the part of the interested parties.

This fact, consequently, generates discomfort and difficulty to the users, due to the enormous volume and existing varieties of items of interest inside of the shopping center, museums and similar ones.

As a way of brighten up the situation, the usual form of searching departments, stores, items in exposition, numbered seats and strategic points, such as point of medical and sanitary attendance and exits of emergency, is made through visual or sonorous indications, by maps, plans, brochures and point of information, however, those dispositions are uncomfortable or difficult of being used, for example: the visual indications point the direction to be followed by the user, however they are restricted to the basic codes of classification, such as feeding square, clothes, parking, exit, information, among other headings, not accurately specifying the desired place, compelling the user to search by means of trial and error, inside the whole group; the sonorous indications point the direction to be followed by the user by means of voice, however imperceptible when the place contains sonorous noises that hide the sound of the emitting source of the information; maps and pamphlets, which dimensions most of the time are limited and insufficient to place all the useful information for the localization of the points of interest of the user.

It was thinking about these inconveniences that, after innumerable research and studies, the inventor, a person related to the field, created and developed the object of the current patent, idealizing a program of three-dimensional simulation where not only the mechanical and functional qualities had been considered in the project of its manufacture, but also the form, the disposal and the localization of its parts and components that, correctly located, had brought an increase of efficiency without any cost.

Thus, the current patent was projected aiming at getting a device with less possible number of parts, conveniently configured and arranged to allow the program of three-dimensional simulation to play its functions with unequal efficiency and versatility, without the already mentioned inconveniences and making possible the easy localization of items of interest of the user.

### BRIEF DESCRIPTION OF THE INVENTION.

It is shown in the current request of patent, a practical and innovative model of program of three-dimensional simulation with all the aesthetic and functional qualities, projected and developed following the most modern techniques, making possible in this way its more varied use, in different cases.

It is of understanding that the mentioned device is extremely simple in its construction, being, therefore, of easy feasibility, however, excellent practical and functional results are gotten, offering an innovative construction on the known models.

Idealized with innovative drawing, characteristic results in a harmonic set, of sufficiently peculiar aspect, and over all, being that, beyond the constructive aspect, the program is distinguished for its versatility and comfort of use.

In relation to what was previously told, the “COMPUTER ORIENTED WAY DEVICE BY THREE-DIMENSIONAL IMAGE”, object of the current patent, is characterized essentially for being constituted of a computer program, being installed in an electronic equipment endowed with monitor and a directive device of the icon of movement of the screen, by touch or voice, that possesses an instantaneous menu of search and searches the place of interest of the user, in different categories of search.

In this way, when the user informs the place of desired destination, the program generates a three-dimensional image about the shortest way to be covered by the user, from the consultation point to the chosen place, followed of notes about the shortest trajectory to be covered by means of an object in movement.

The program makes possible that the user executes the consultation in real time, illustrating instantaneously where the products he is looking for are situated, the pieces and works of art (in the museum case), the chairs or tables (in the case of houses of entertainment), departments (in the case of companies), among other innumerable items.

Moreover, the computer program could also be freely available for consultation in the world-wide net of computers or to be available in CD or similar superior or upper for free distribution between the customers.

Still, the program also makes possible to add promoting mechanisms that use audiovisual resources, as a way to call the attention of the customers and commercial, cultural and similar visitors of the great shopping centers, museums, fairs, events and many others.

It can thus be noticed that the current “COMPUTER ORIENTED WAY DEVICE BY THREE-DIMENSIONAL IMAGE”, is characterized as a device of great utility, presenting all the practical qualities and of feasibility that fully justifies the order of Patent of Invention.

1. “COMPUTER ORIENTED WAY DEVICE BY THREE-DIMENSIONAL IMAGE” which aim is to facilitate to the localization of departments, store, items in exposition, numbered seats and strategic points of great shopping centers, museums, big stores, supermarkets, companies, houses of entertainment, theaters, fairs, events, among others to be located, characterized for being constituted of a computer program, installed in an electronic equipment endowed with monitor and a directive device of the icon of movement of the screen, by touch or voice, that possesses an instantaneous menu of search and searches the place of interest of the user, in different categories of search, so that, when the user informs the place of desired destination, the program generates a three-dimensional image about the shortest and better way to be covered by the user, from the consultation point to the chosen place, followed of notes about the shortest trajectory to be covered by means of an object in movement.

2. “COMPUTER ORIENTED WAY DEVICE BY THREE-DIMENSIONAL IMAGE” according to claim 1, characterized by the computer program, installed in the electronic equipment, to make possible the consultation to be executed in real time, illustrating instantaneously where the products, places or items looked by the user are situated.

3. “COMPUTER ORIENTED WAY DEVICE BY THREE-DIMENSIONAL IMAGE” according to claim 1, characterized for the computer program to add promoting mechanisms that use audiovisual resources, as a way to call the attention the customers and visitors of the place where the electronic equipment contained in the program is installed.

4. “COMPUTER ORIENTED WAY DEVICE BY THREE-DIMENSIONAL IMAGE” according to claim 1, characterized for the computer program to make possible to be freely available for consultation in the world-wide net of computers.

5. “COMPUTER ORIENTED WAY DEVICE BY THREE-DIMENSIONAL IMAGE” according to claim 1, characterized for the computer program to make possible to be available in CD or similar superior or upper for free distribution between the customers.
